(19) United States
(12) Patent Application Publication
(10) Pub. No.: US 2008/0175781 A1
(43) Pub. Date: Jul. 24, 2008

(54) Bootstrap synthesis of boranes

(75) Inventors: David L. Thorn, Los Alamos, NM (US); William Tumas, Los Alamos, NM (US)

Correspondence Address: LOS ALAMOS NATIONAL SECURITY, LLC, LOS ALAMOS NATIONAL LABORATORY, PPO. BOX 1663, LC/IP, MS A187, LOS ALAMOS, NM, 87545, US

(73) Assignee: The Regents of the University of California

(21) Appl. No.: 11/901,007

(22) Filed: Sep. 13, 2007

Related U.S. Application Data
(60) Provisional application No. 60/847,031, filed on Sep. 22, 2006.

(51) Int. Cl. C01B 35/14; C07F 5/02

(52) U.S. Cl. 423/285; 564/9; 568/6; 546/13; 548/405

(57) ABSTRACT

Metal hydride materials react with BZ₃ compounds in the presence of ligand to form BH₃-L compounds. A compound of the formula HBZ₂ is prepared from a compound of the formula BZ₃ by reacting a first amount of a compound of the formula HBZ₂ with a metal hydride material “MH” and a compound “L” to form a material of the formula BH₃-L, and then reacting the BH₃-L thus formed with a compound of the formula BZ₃ to form HBZ₂ in a second amount greater than the first amount of HBZ₂. Z is selected from alkoxy, aryloxy, amido, arylamido, doubly substituted alkoxy, doubly substituted aryloxy, doubly substituted amido, doubly substituted arylamido, alkoxy-amido, and aryloxy-arylamido. When Z is bidentate, then HBZ₂ has a ring structure. “L” is selected from ethers, aromatic ethers, amines, aromatic amines, heterocyclic nitrogen compounds, sulfides, aromatic sulfides, and heterocyclic sulfur compounds. “L” becomes a ligand in the BH₃-L material.

### RELATED APPLICATIONS

This application claims the benefit of U.S. Provisional Patent Application Ser. No. 60/847,031 entitled BOOTSTRAP SYNTHESIS OF BORANES filed Sep. 22, 2006, hereby incorporated by reference.

### STATEMENT REGARDING FEDERAL RIGHTS

This invention was made with government support under Contract No. DE-AC52-06NA25396 awarded by the U.S. Department of Energy. The government has certain rights in the invention.

### FIELD OF THE INVENTION

The present invention relates generally to boranes, and more particularly to a synthesis of ligand-stabilized BH₃.

### BACKGROUND OF THE INVENTION

Hydrogen (H₂) is currently a leading candidate for a fuel to replace gasoline/diesel fuel in powering the nation's transportation fleet. There are a number of difficulties and technological barriers associated with hydrogen that must be solved in order to realize this “hydrogen economy”. Inadequate storage systems for on-board transportation of hydrogen are recognized as a major technological barrier (see, for example, “The Hydrogen Economy: Opportunities, Costs, Barriers, and R&D Needs,” National Academy of Engineering (NAE), Board on Energy and Environmental Systems, National Academy Press (2004)).

One of the general schemes for storing hydrogen relates to using a chemical compound or system that undergoes a chemical reaction to evolve hydrogen as a reaction product. In principle, this chemical storage system is attractive, but systems that have been developed to date involve either: (a) hydrolysis of high-energy inorganic compounds where the evolution of hydrogen is very exothermic (sodium borohydride/water as in the Millennium Cell's HYDROGEN ON DEMAND®, and lithium (or magnesium) hydride as in SAFE HYDROGEN®, for example), thus making the cost of preparing the inorganic compound(s) high and life-cycle efficiency low; or (b) dehydrogenation of inorganic hydride materials (such as Na₃AlH₆/NaAlH₄, for example) that release hydrogen when warmed but that typically have inadequate mass storage capacity and inadequate refueling rates.

Inorganic compounds referred to in (a), above, produce hydrogen according to the chemical reaction

MHₓ+X H₂O→M(OH)ₓ+X H₂ (1)

where MHₓ is a metal hydride, and M(OH)ₓ is a metal hydroxide. This reaction is irreversible.

Inorganic hydride materials referred to in (b), above, produce hydrogen according to the following chemical reaction, which is reversible with H₂ (hydrogen gas):

MHₓ=M+x/2 H₂ (2)

where MHₓ is a metal hydride, M is metal and H₂ is hydrogen gas. By contrast to the first reaction, which is irreversible with H₂, the second reaction is reversible with H₂.

A practical chemical system that evolves hydrogen yet does not suffer the aforementioned inadequacies would be important to the planned transportation sector of the hydrogen economy. This same practical chemical system would also be extremely valuable for non-transportation H₂ fuel cell systems, such as those employed in laptop computers and other portable electronic devices, and in small mechanical devices such as lawnmowers where current technology causes significant pollution concerns.

Any heat that must be input to evolve the hydrogen represents an energy loss at the point of use, and any heat that is evolved along with the hydrogen represents an energy loss where the chemical storage medium is regenerated. Either way, energy is lost, which diminishes the life-cycle efficiency. For most organic compounds, such as in those shown in equations 3-5 below, hydrogen evolution reactions are very endothermic, and also endergonic at ambient temperature (endergonic means having a net positive standard free energy of reaction change, i.e. ΔG⁰>0). As a consequence the ambient temperature equilibrium hydrogen pressure is very low, practically unobservable, and the compounds are thermodynamically incapable of evolving H₂ at significant pressure at ambient temperature. For temperatures less than about 250-400 degrees Celsius, the equilibrium pressure of hydrogen over most organic compounds remains very small. Most common organic compounds require heating above about 250 degrees Celsius to exhibit a significant equilibrium pressure of hydrogen, and owing to the endothermic nature of hydrogen evolution for most organic compounds, high-grade heat must be continuously supplied to maintain this temperature and sustain the evolution of hydrogen at a useful pressure.

CH₄→C+2 H₂

ΔH⁰=+18 kcal/mol

ΔG⁰=+12 kcal/mol (3)

6 CH₄→cyclohexane+6 H₂

ΔH⁰=+69 kcal/mol

ΔG⁰=+78 kcal/mol (4)

cyclohexane→benzene+3 H₂

ΔH⁰=+49 kcal/mol

ΔG⁰=+23 kcal/mol (5)

Most organic compounds are unsuitable for hydrogen storage, based on considerations of thermodynamics, life-cycle energy efficiency, and delivery pressure. An organic compound that has been studied for use as hydrogen storage, decalin, evolves hydrogen to form naphthalene when heated to about 250 degrees Celsius in the presence of a catalyst (see, for example, Hodoshima et al. in “Catalytic Decalin Dehydrogenation/Naphthalene Hydrogenation Pair as a Hydrogen Source for Fuel-Cell Vehicle,” Int. J. Hydrogen Energy (2003) vol. 28, pp. 1255-1262, incorporated by reference herein). Hodoshima et al. use a superheated “thin film” reactor that operates at a temperature of at least 280 degrees Celsius to produce hydrogen from decalin at an adequate rate and pressure. Thus, this endothermic hydrogen evolution reaction requires both a complex apparatus and high-grade heat, which diminishes the life-cycle energy efficiency for hydrogen storage.

Boranes, which are compounds having at least one B—H bond, have high hydrogen storage capacities and favorable thermodynamics for hydrogen evolution at ambient temperature and have attracted interest for use as hydrogen storage materials for transportation. However, the difficulty and the life-cycle energy inefficiency of the chemical processes presently used for their manufacture have prevented their widespread use for this purpose.

Owing to its commercial availability, NaBH₄ (sodium borohydride) is a starting material typically used to prepare borane compounds. Diborane (B₂H₆), for example, is prepared in a laboratory by reacting NaBH₄ with BF₃. Borohydride compounds (i.e. compounds containing the BH₄ anion or other anionic B—H groups) are generally prepared by reacting alkoxyborates with active metal hydrides e.g. NaH or NaAlH₄. Sodium borohydride itself (NaBH₄), for example, is commercially prepared using the known Schlessinger process, which involves reacting sodium hydride (NaH) with trimethoxyboron (B(OCH₃)₃). While convenient to practice on a small or intermediate laboratory or commercial scale, these reactions are not energy-efficient; the reaction of NaH with B(OCH₃)₃ is exothermic, and NaH is itself formed in the exothermic reaction of Na metal with H₂, so overall, about 22 kcal of heat are released per B—H bond that is formed.

Other means are known for forming B₂H₆. The best known is the reaction of BCl₃ with H₂ at high temperature to make BHCl₂ and HCl. Significant equilibrium conversion is possible only if the temperature is on the order of about 600 degrees Celsius or more, and the product mixture must be rapidly quenched, typically within a few seconds, to a temperature below about 100 degrees Celsius to allow BHCl₂ to disproportionate to B₂H₆ and BCl₃. The quenched mixture must be separated rapidly before the B₂H₆ back-reacts with the HCl coproduct. BCl₃ and HCl are both highly corrosive. Their corrosive properties in combination with the difficulties of heat management make this process costly to practice.

Another means of forming B₂H₆ is high-temperature or plasma-assisted decomposition of B(OCH₃)₃, but this requires input of significant amounts of energy and the overall process is not energy efficient.

BH₃-containing compounds have potential application for use as hydrogen storage compounds, and any means that facilitates their preparation could have widespread application. Present means of preparing BH₃-containing compounds are cumbersome and energy-inefficient as described above. A common theme in these methods is that B—H species are prepared using either B-Halogen precursors that may be difficult to obtain, or B—OR precursors that are difficult to react to form B—H species.

Presently, there is no energy efficient means available for preparing BH₃-containing compounds. Methods and systems that employ borane-based chemical compounds for storing and evolving hydrogen at ambient temperature with minimal heat input remain highly desirable.

### SUMMARY OF THE INVENTION

In accordance with the purposes of the present invention, as embodied and broadly described herein, the present invention includes a method for preparing a compound of the formula HBZ₂ from a compound of the formula BZ₃. The method includes reacting a first amount of a compound of the formula HBZ₂ with a metal hydride material “MH” and a compound “L” to form a material of the formula BH₃-L. Z can be a monodentate group or a bidentate group. Monodentate groups include, but are not limited to, alkoxy, aryloxy, amido, and arylamido. Bidentate groups include, but are not limited to, doubly substituted alkoxy, doubly substituted aryloxy, doubly substituted amido, doubly substituted arylamido, alkoxy-amido, and aryloxy-arylamido. A bidentate group functions as two Z. Compounds with bidentate groups have a ring structure. The compound “L” is selected from the group consisting of ethers, aromatic ethers, amines, aromatic amines, heterocyclic nitrogen compounds, sulfides, aromatic sulfides, and heterocyclic sulfur compounds; and reacting the BH₃-L thus formed with a compound of the formula BZ₃ to form a second amount of HBZ₂ that is greater than the first amount of HBZ₂.

The invention also includes a method for preparing a compound of the formula BH₃-L from a compound of the formula BZ₃. The method includes reacting a first amount of a compound of the formula HBZ₂ with an metal hydride material and a compound “L” to form a material of the formula BH₃-L. Z can be a monodentate group or a bidentate group. Monodentate groups include, but are not limited to, alkoxy, aryloxy, amido, and arylamido. Bidentate groups include, but are not limited to, doubly substituted alkoxy, doubly substituted aryloxy, doubly substituted amido, doubly substituted arylamido, alkoxy-amido, and aryloxy-arylamido. A bidentate group functions as two Z. Compounds with bidentate groups have a ring structure. The compound “L” is selected from the group consisting of ethers, aromatic ethers, amines, aromatic amines, heterocyclic nitrogen compounds, sulfides, aromatic sulfides, and heterocyclic sulfur compounds, and reacting a portion of the BH₃-L thus formed with an amount of compound of the formula BZ₃ to form a second amount of HBZ₂, wherein the amount of BZ₃ is chosen such that the second amount of HBZ₂ and the first amount of HBZ₂ are about the same amount.

The invention also includes a method of forming BH₃-amine or BH₃-ammonia. The method involves reacting HBZ₂ with a compound “X” that promotes a disproportionation of HBZ₂ to a BH₃-X compound; and thereafter reacting the BH₃-X compound with a compound that comprises ammonia or amine, or mixtures thereof, to form BH₃-L. L comprises ammonia or amine. Z can be a monodentate group or a bidentate group. Monodentate groups include, but are not limited to, alkoxy, aryloxy, amido, and arylamido. Bidentate groups include, but are not limited to, doubly substituted alkoxy, doubly substituted aryloxy, doubly substituted amido, doubly substituted arylamido, alkoxy-amido, and aryloxy-arylamido. A bidentate group functions as two Z. Compounds with bidentate groups have a ring structure.

The invention also includes a method of forming BH₃-ammonia. The method involves reacting a first amount of a compound of the formula HBZ₂ with an metal hydride material “MH” and a compound “L” to form a material of the formula BH₃-L. Z can be a monodentate group or a bidentate group. Monodentate groups include, but are not limited to, alkoxy, aryloxy, amido, and arylamido. Bidentate groups include, but are not limited to, doubly substituted alkoxy, doubly substituted aryloxy, doubly substituted amido, doubly substituted arylamido, alkoxy-amido, and aryloxy-arylamido. A bidentate group functions as two Z. Compounds with bidentate groups have a ring structure. Compound “L” is selected from the group consisting of ethers, aromatic ethers, amines, aromatic amines, heterocyclic nitrogen compounds, sulfides, aromatic sulfides, and heterocyclic sulfur compounds, and reacting a portion of the BH₃-L thus formed with an amount of compound of the formula BZ₃ to form a second amount of HBZ₂, wherein the amount of BZ₃ is chosen such that the second amount of HBZ₂ and the first amount of HBZ₂ are about the same amount, and reacting the remaining BH₃-L with ammonia to make BH₃-ammonia.

The invention also includes a method for preparing a compound of the formula BH₃-L. The method involves reacting a compound of the formula HBZ₂ with a metal hydride material “MH” and a compound “L”. Z can be a monodentate group or a bidentate group. Monodentate groups include, but are not limited to, alkoxy, aryloxy, amido, and arylamido. Bidentate groups include, but are not limited to, doubly substituted alkoxy, doubly substituted aryloxy, doubly substituted amido, doubly substituted arylamido, alkoxy-amido, and aryloxy-arylamido. A bidentate group functions as two Z. Compounds with bidentate groups have a ring structure. Compound “L” is selected from the group consisting of ethers, aromatic ethers, amines, aromatic amines, heterocyclic nitrogen compounds, sulfides, aromatic sulfides, and heterocyclic sulfur compounds.

### DETAILED DESCRIPTION

The present invention provides an energy efficient method for synthesizing boranes, which are boron compounds that have at least one B—H bond. These boranes may be used for storing hydrogen. Using this invention, boranes are prepared with considerably less heat of reaction than present methods. The invention may enable widespread use of boranes for hydrogen storage for transportation.

In some embodiments of the invention, metal hydride materials are used to reduce compounds of the formula HBZ₂ to compounds of the formula H₃B-L, where “L” is referred to as a ligand when in the bound state, but as a separate compound when in the unbound state. The H₃B-L compounds are then made to react with compounds of the formula BZ₃, which results in forming more HBZ₂ than was used to initiate the reaction. By this process, the overall reaction, the conversion of BZ₃ to HBZ₂ using, for example, metal hydride material(s) as reducing agent(s), can proceed at useful rates even when the metal hydride material(s) used for reduction do not react directly with BZ₃ at useful rates. This type of conversion is referred to herein generally as “bootstrapping”, or “bootstrap reduction”, or “bootstrap” formation of HBZ₂ or H₃B-ligand compounds from BZ₃.

An advantage of this “bootstrap” method of the invention is that B—H compounds can be made from BZ₃ compounds using metal hydride material(s) that react only slowly with, or may not react at observable rates with, BZ₃ itself. Another advantage of this “bootstrap” method of the invention is that B-halogen compounds are not required, which avoids any requirement involving the synthesis of B-halogen compounds and issues related to the corrosivity and waste-management associated with making and handling such compounds.

The boranes synthesized using this invention may be starting materials for conversion to borohydride compounds for subsequent use as chemical reducing agents or as chemical hydrogen storage media.

Having briefly described the invention, a more detailed description now follows. H—B containing compounds are prepared from compounds of the formula BZ₃ by a “bootstrapping” method, wherein a compound of the formula HBZ₂ is reduced by “MH” (a metal hydride material) to a compound of the formula H₃B-L (see equation lb below), and H₃B-L reacts with BZ₃ to make more HBZ₂ (see equation 1a below). The net transformation is summarized in equation 2 below.

2 BZ₃+H₃B-L=3 HBZ₂+L (1a)

HBZ₂+2 “MH”+L=H₃B-L+2 “MZ” (1b)

2 BZ₃+2 “MH”=2 HBZ₂+2 “MZ” (2)

In the above equations, Z=alkoxy (—OR where R is alkyl) or aryloxy group (—OAr), e.g. —OCH₃, —OCH₂CH₃, —O(CH₂)ₙCH₃ where n is an integer 2-12, —OCH(CH₃)₂, —OC(CH₃)₃, —OC₆H₅; or amido or arylamido group, e.g. —N(CH₃)₂, —N(C₂H₅)₂, —N(C₃H₇)₂, —N(CH₂)₄ (pyrrolidino), —N(CH₂)₅ (piperidino), —NH(C₆H₅), —N(CH₃)(C₆H₅), —N(C₂H₅)(C₆H₅). A bidentate group may serve as two Z. Such bidentate groups include, but are not limited to, doubly substituted alkoxy (1,2-ethyleneglycolato, 1,2-propyleneglycolato, for example), aryloxy (1,2-catecholato, for example), amido, arylamido (ortho-amidophenolato, (N,N′-dimethyl)phenylenediamido, for example), alkoxy-amido, and aryloxy-arylamido. When a bidentate group is used, the compound has a ring structure, such as

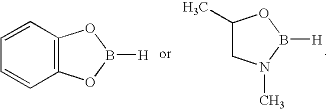

“MH” refers to an metal hydride material, such as, but not limited to, a Si—H material; a Sn—H material; a hydrided electrode surface; hydrided surfaces of materials that include metals such as, but not limited to, zinc, gallium, silicon, germanium, indium, cadmium, tin, mercury, and mixtures thereof; and molecular compounds of silicon, germanium, tin, aluminum, gallium, indium, zinc, cadmium, mercury, or a transition metal containing one or more hydrogen atoms bonded directly to the silicon, germanium, tin, aluminum, gallium, indium, zinc, cadmium, mercury, or transition metal. Ligands useful with the invention include, but are not limited to, ethers, aromatic ethers, amines, aromatic amines, heterocyclic nitrogen compounds, sulfides, aromatic sulfides, and heterocyclic sulfur compounds. Preferred ligands are substituted aromatic amines.

An advantage of this method is that it allows the net transformation of BZ₃ and “MH” to HBZ₂ in situations where the direct reaction between BZ₃ and “MH” may be too slow to be useful. It is easier, for example, to reduce a H—B(OR)₂ compound to a H₃B-L compound using “MH” than to reduce a B(OR)₃ compound directly to an H—B-containing compound using “MH”. Once the H₃B-L compounds are formed, they can be made to react with B(OR)₃ compounds to obtain more of the H—B(OR)₂ compound, hence, “bootstrap” the formation of H—B(OR)₂ or H₃B-L compounds from B(OR)₃.

In some embodiments, depending upon the choice of Z, the accumulating compound HBZ₂ may subsequently be driven to disproportionate to a BH₃-L compound in the presence of ligand L (Equations 3a-b below) and thereafter converted to, for example, BH₃—NH₃ if that be the desired final product (Equation 3c, where L′ is ammonia). An overall sequence of reactions is outlined in Equations 3a-3c below, with the net transformation summarized in Equation 4.

6 BZ₃+3 H₃B-L=9 HBZ₂+3 L (3a)

3 HBZ₂+6 “MH”+3 L=3 H₃B-L+6 “MZ” (3b)

6 HBZ₂+2 L′=4 BZ₃+2 H₃B-L′ (3c)

2 BZ₃+6 “MH”+2 L′=2 H₃B-L′+6 “MZ” (4)

An advantage of this method is that it allows the net transformation of BZ₃, “MH” and L to H₃B-L in situations where the direct reaction between BZ₃ and “MH” may be too slow to be useful.

In some embodiments, H₃B-L accumulates directly in a single reaction mixture. In these embodiments, reactions of Equations 5a and 5b (shown below) occur nearly simultaneously, and HBZ₂ is used about as fast as it is formed and thus becomes a reaction intermediate that is not isolated and recovered.

2 BZ₃+H₃B-L=3 HBZ₂+L (5a)

3 HBZ₂+6 “MH”+3 L=3 H₃B-L+6 “MZ” (5b)

2 BZ₃+6“MH”+2 L=2 H₃B-L+6 “MZ” (6)

An advantage of this method is that it allows for a simple transformation process of BZ₃, “MH” and L to H₃B-L in situations where the direct reaction between BZ₃ and “MH” may be too slow to be useful and the isolation of any intermediate compound may be undesirable.

The following EXAMPLES illustrate embodiments of the invention.

### EXAMPLE 1

A mixture of B₂Cat₃ (0.13 grams) and PhSiH₃ (0.20 grams) was prepared and then heated at a temperature of about 50 degrees Celsius for about 15 hours. The mixture was then allowed to cool to room temperature, dissolved in deuterotetrahydrofuran (about 1 ml), and analyzed by ¹H and ¹¹B NMR spectroscopy. In the ¹¹B NMR spectrum, the bulk Of the ¹¹B signal was that of unreacted B₂Cat₃ (19 ppm, singlet) but there was a small signal for catecholborane (HBCat) (25 ppm, doublet, J_{BH}=189 Hz) with an estimated intensity of about 1-5% that of B₂Cat₃. The deuterotetrahydrofuran solution was then heated to a temperature of about 50 degrees Celsius for about 21 hours and again analyzed by ¹¹B NMR spectroscopy. The signal for HBCat was much more intense relative to the signal for B₂Cat₃, estimated peak ratios on the order of about 1:1. The conclusion from this observation is that the reaction between B₂Cat₃ and PhSiH₃ occurs much more rapidly in the presence of tetrahydrofuran solution than in the absence of tetrahydrofuran, which is consistent with tetrahydrofuran playing a role in promoting the reaction. The solution was then heated to 50 degrees Celsius for an additional 29 hours and analyzed again by ¹¹B NMR spectroscopy. The signal for HBCat now dominated the ¹¹ B spectrum with an estimated 90% the total ¹¹B signal intensity, with signals for B₂Cat₃ and BH₃-THF (0 ppm, quartet, J_{BH}=107 Hz) also visible, estimated 5% each of the total ¹¹B signal intensity. This is consistent with the formation of the BH₃-containing compound BH₃-THF in the reaction between HBCat and PhSiH₃, and the accumulation of BH₃-THF when the subsequent reaction between BH₃-THF and B₂Cat₃ becomes slow owing to depletion of B₂Cat₃.

### EXAMPLE 2

A first solution of B₂Cat₃ (0.09 grams) and PhSiH₃ (0.102 grams) in deuterotetrahydrofuran (about 1 milliliter) was prepared. A second solution of B₂Cat₃ (0.09 grams), PhSiH₃ (0.102 grams) and HBCat (0.058 grams) in deuterotetrahydrofuran (about 1 milliliter) was also prepared. Both solutions were heated to a temperature of about 50 degrees Celsius for about 17.5 hours, and afterward were analyzed by ¹¹B NMR. In the first solution (i.e. the one prepared without the added HBCat), approximately 54% (+/− estimated 10%) of the B₂Cat₃ had been converted to HBCat. In the second solution (the one prepared with added HBCat), approximately 81% (+/− estimated 10%) of the B₂Cat₃ had been converted to HBCat. These results strongly support a conclusion that HBCat promotes the conversion of B₂Cat₃ to HBCat. Further heating of both solutions resulted in the formation of noticeable amounts of BH₃-THF and other BH-containing species.

### EXAMPLE 3

A solution containing HBCat (0.019 grams) and HSnBu₃ (0.098 grams) in deuterotetrahydrofuran (about 1 milliliter) was heated for about 2 days at a temperature of about 50 degrees Celsius, and then analyzed by ¹¹B NMR. A small signal at 0 ppm was observed, consistent with the presence of small amounts of BH₃-THF. The solution was heated at the same temperature for about 11 days and again analyzed by ¹¹B NMR. The signal for BH₃-THF (0 ppm, quartet) was considerably larger, consistent with the formation of additional amounts of BH₃-THF, along with other boron-containing compounds. This strongly suggests that the tin hydride compound HSnBu₃ reacts with HBCat to make BH₃-THF, although slowly under these conditions.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

What is claimed is:

1. A method for preparing a compound of the formula HBZ₂ from a compound of the formula BZ₃, comprising:
reacting a first amount of a compound of the formula HBZ₂ with a metal hydride material “MH” and a compound “L” to form a material of the formula BH₃-L, wherein Z comprises alkoxy, aryloxy, amido, arylamido, or mixtures thereof, wherein two Z comprises doubly-substituted alkoxy, doubly-substituted aryloxy, doubly-substituted amido, doubly substituted arylamido, alkoxy-amido, and aryloxy-arylamido, wherein the compound “L” comprises ethers, aromatic ethers, amines, aromatic amines, heterocyclic nitrogen compounds, sulfides, aromatic sulfides, and heterocyclic sulfur compounds, and
reacting the BH₃-L thus formed with a compound of the formula BZ₃ to form a second amount of HBZ₂ that is greater than the first amount of HBZ₂.

2. The method of claim 1, wherein the metal hydride material “MH” is a material selected from the group consisting of inorganic metal hydride materials and organic metal hydride materials.

3. The method of claim 1, wherein the metal hydride material “MH” comprises a material with at least one Si—H bond, a material with at least one Sn—H bond, a hydrided electrode surface, or a hydrided surface, wherein the hydrided surface comprises zinc, gallium, silicon, germanium, indium, cadmium, tin, mercury, or mixtures thereof.

4. The method of claim 1, wherein the metal hydride material “MH” comprises a molecular compound or a transition metal with at least one hydrogen directly bonded to the transition metal, wherein the molecular compound comprises silicon, germanium, tin, aluminum, gallium, indium, zinc, cadmium, mercury, or combinations thereof.

5. The method of claim 1, wherein Z is selected from the group consisting of —OCH₃, —OCH₂CH₃, —O(CH₂)ₙCH₃ where n is an integer of from 2 to 12, —OCH(CH₃)₂, —OC(CH₃)₃, —OC₆H₅, —N(CH₃)₂, —N(C₂H₅)₂, —N(C₃H₇)₂, —N(CH₂)₄ (pyrrolidino), —N(CH₂)₅ (piperidino), —NH(C₆H₅), —N(CH₃)(C₆H₅), and —N(C₂H₅)(C₆H₅).

6. The method of claim 1, wherein the Z₂ portion of HBZ₂ comprises 1,2-catecholato, 1,2-phenylenediamido, 1,2-ethyleneglycolato, 1,2-propyleneglycolato, (N,N′-dimethyl)phenylenediamido, or ortho-amidophenolato.

7. The method of claim 1, further comprising forming a metal hydride material by an electrochemical reaction of a metal to form a metal hydride material before reacting the metal hydride material with BZ₃.

8. The method of claim 6, wherein the metal hydride material formed by electrochemical reaction of the metal comprises a surface metal hydride or a bulk metal hydride.

9. The method of claim 1, wherein the metal hydride material comprises silicon, tin, zinc, gallium, germanium, indium, cadmium, mercury, or mixtures thereof.

10. The method of claim 1, wherein the metal hydride material comprises an electrode.

11. The method of claim 1, wherein the metal hydride material comprises at least one compound of the formula R₃SnH, R₂XSnH, RX₂SnH, or X₃SnH, wherein R is selected from alkyl and aryl, and wherein X is selected from halogen.

12. A method for preparing a compound of the formula BH₃-L from a compound of the formula BZ₃, comprising:
reacting a first amount of a compound of the formula HBZ₂ with an metal hydride material and a compound “L” to form a material of the formula s BH₃-L, wherein Z comprises alkoxy, aryloxy, amido, arylamido, or mixtures thereof, wherein two Z comprises doubly-substituted alkoxy, doubly-substituted aryloxy, doubly-substituted amido, doubly substituted arylamido, alkoxy-amido, or aryloxy-arylamido, wherein the compound “L” comprises ethers, aromatic ethers, amines, aromatic amines, heterocyclic nitrogen compounds, sulfides, aromatic sulfides, and heterocyclic sulfur compounds, and
reacting a portion of the BH₃-L thus formed with an amount of compound of the formula BZ₃ to form a second amount of HBZ₂, wherein the amount of BZ₃ is chosen such that the second amount of HBZ₂ and the first amount of HBZ₂ are about the same amount.

13. A method of forming BH₃-L where L is ammonia or amine, comprising:
reacting HBZ₂ with a compound “X” that promotes a disproportionation of HBZ₂ to a BH₃-X compound; and thereafter
reacting the BH₃-X compound with a compound “L” comprising ammonia or amine to form BH₃-L, wherein L comprises ammonia or amine, and wherein Z comprises alkoxy, aryloxy, amido, arylamido, wherein two Z comprises doubly-substituted alkoxy, doubly-substituted aryloxy, doubly-substituted amido, doubly substituted arylamido, alkoxy-amido, or aryloxy-arylamido.

14. A method of forming BH₃-ammonia, comprising:
reacting a first amount of a compound of the formula HBZ₂ with an metal hydride material “MH” and a compound “L” to form a material of the formula BH₃-L, wherein Z comprises alkoxy, aryloxy, amido, arylamido, or mixtures thereof, wherein two Z comprises doubly-substituted alkoxy, doubly-substituted aryloxy, doubly-substituted amido, doubly substituted arylamido, alkoxy-amido, or aryloxy-arylamido, wherein compound “L” comprises ethers, aromatic ethers, amines, aromatic amines, heterocyclic nitrogen compounds, sulfides, aromatic sulfides, or heterocyclic sulfur compounds,
reacting a portion of the BH₃-L thus formed with an amount of compound of the formula BZ₃ to form a second amount of HBZ₂, wherein the amount of BZ₃ is chosen such that the second amount of HBZ₂ and the first amount of HBZ₂ are about the same amount, and
reacting the remaining BH₃-L with ammonia to make BH₃-ammonia.

15. A method for preparing a compound of the formula BH₃-L, comprising:
reacting a compound of the formula HBZ₂ with a metal hydride material “MH” and a compound “L”, wherein Z comprises alkoxy, aryloxy, amido, arylamido, or mixtures thereof, wherein two Z comprises doubly-substituted alkoxy, doubly-substituted aryloxy, doubly-substituted amido, doubly substituted arylamido, alkoxy-amido, or aryloxy-arylamido, wherein compound “L” comprises ethers, aromatic ethers, amines, aromatic amines, heterocyclic nitrogen compounds, sulfides, aromatic sulfides, or heterocyclic sulfur compounds.
